(19) United States
(12) Patent Application Publication
(10) Pub. No.: US 2015/0016019 A1
(43) Pub. Date: Jan. 15, 2015

(54) MULTILAYER CERAMIC ELECTRONIC COMPONENT TO BE EMBEDDED IN BOARD

(71) Applicant: SAMSUNG ELECTRO-MECHANICS CO., LTD., Suwon-Si (KR)

(72) Inventors: Eun Hyuk CHAE, Suwon-si (KR); Doo Young KIM, Suwon-si (KR); Byoung Hwa LEE, Suwon-Si (KR); Jin Woo LEE, Suwon-Si (KR); Kyu Ree KIM, Suwon-Si (KR)

(21) Appl. No.: 14/331,019

(22) Filed: Jul. 14, 2014

(30) Foreign Application Priority Data
Jul. 15, 2013 (KR) 10-2013-0082819

(51) Int. Cl. H01G 4/008; H01G 4/30

(52) U.S. Cl. CPC H01G 4/008; H01G 4/30
USPC 361/301.4

(57) ABSTRACT

A multilayer ceramic electronic component to be embedded in a board may include: a ceramic body in which a plurality of dielectric layers are stacked; a plurality of first and second internal electrodes alternately exposed through both end surfaces of the ceramic body, respectively, with at least one of the dielectric layers interposed therebetween; and first and second external electrodes disposed on the end surfaces of the ceramic body and electrically connected to the first and second internal electrodes, respectively. Each of the first and second external electrodes includes a first external electrode layer containing a glass component and disposed on the end surface of the ceramic body and a second external electrode layer being glass-free and covering the first external electrode layer.

### CROSS-REFERENCE TO RELATED APPLICATION

This application claims the benefit of Korean Patent Application No. 10-2013-0082819 filed on Jul. 15, 2013, with the Korean Intellectual Property Office, the disclosure of which is incorporated herein by reference.

### BACKGROUND

The present disclosure relates to a multilayer ceramic electronic component to be embedded in a board.

Examples of electronic components in which a ceramic material is used include capacitors, inductors, piezoelectric elements, varistors, thermistors, and the like.

A multilayer ceramic capacitor, which is a type of multilayer chip electronic components, is a chip type condenser mounted on circuit boards of various electronic products such as display devices, including liquid crystal displays (LCDs), plasma display panels (PDPs), and the like, computers, personal digital assistants (PDAs), mobile phones, and the like, and serving to charge and discharge electricity.

Since multilayer ceramic capacitors (MLCCs) have advantages such as a relatively small size, high capacitance, ease of mounting, and the like, multilayer ceramic capacitors may be used as components in various electronic devices.

Recently, as the levels of performance of portable smart devices such as smartphones, tablet personal computers (PCs), and the like, have been improved, the driving speeds of application processors (APs) carrying out calculations have increased.

When the driving speed of the AP is increased as described above, a high frequency current should be rapidly supplied to the AP.

The multilayer ceramic capacitor serves to supply current to the AP. Therefore, in order to rapidly supply the high frequency current to the AP, a multilayer ceramic capacitor having low equivalent series inductance (ESL) should be used or a multilayer ceramic capacitor should be embedded in aboard to decrease a distance between the multilayer ceramic capacitor and the AP as much as possible.

In the case in which the multilayer ceramic capacitor is manufactured to have low ESL, corresponding to the former case, further problems may occur due to a structure of the multilayer ceramic capacitor. Therefore, recently, research into multilayer ceramic capacitors embedded in boards, corresponding to the latter case, has been actively conducted.

Such an embedded multilayer ceramic capacitor commonly includes a ceramic body in which a plurality of dielectric layers and internal electrodes are alternately stacked, and external electrodes, and further includes metal layers formed on surfaces of the external electrodes through an electroplating or electroless plating scheme and containing copper (Cu) as a main component.

After the multilayer ceramic capacitor is embedded in the board, the metal layers may serve to electrically connect the multilayer ceramic capacitor to a circuit of the board through a process of forming via holes using a laser beam and a plating process of filling the via holes using copper (Cu).

That is, after the multilayer ceramic capacitor is embedded in the board, the via holes are formed to penetrate through a resin using the laser beam to expose the external electrodes of the multilayer ceramic capacitor, and are then filled with copper by the plating process, whereby external wirings and the external electrodes of the multilayer ceramic capacitor are electrically connected to each other.

Here, the external electrodes may contain a glass component in order to improve adhesive strength with the ceramic body and have a dense structure after being sintered.

In the case in which the metal layers are not present on the surfaces of the external electrodes, the laser beam may be scattered and reflected by the glass component of the external electrodes, leading to damage to the resin portion surrounding the external electrodes.

However, in a case in which a plating solution permeates through pores in the external electrodes during the metal layer forming process, insulation reliability of the ceramic body may be decreased. Therefore, a content of the glass component in the external electrodes is increased in order to form the external electrodes to have a denser structure.

However, in the case that the content of the glass component in the external electrodes is increased as described above, a pin-hole defect in which plating is not adequately performed on the glass portions of the external electrodes may occur due to a beading phenomenon in which the glass component moves to the surfaces of the external electrodes, or the glass component may be concentrated on interfaces between the external electrodes and the ceramic body to reduce electrical connectivity between the internal electrodes and the external electrodes, resulting in a decrease in capacitance.

In addition, in a heat treating process before measurement and selection, a plating solution trapped in the external electrodes may swell, causing blister defects.

### SUMMARY

An aspect of the present disclosure may provide a new method capable of forming vias using a laser beam without plating metal layers on surfaces of external electrodes, and capable of preventing a pin-hole defect, a blister defect, and a decrease in capacitance in manufacturing a multilayer ceramic electronic component to be embedded in a board.

According to exemplary embodiment of the present disclosure, an embedded multilayer ceramic electronic component may include: a ceramic body in which a plurality of dielectric layers are stacked; a plurality of first and second internal electrodes disposed to be alternately exposed to both end surfaces of the ceramic body, respectively, with at least one of the dielectric layers interposed therebetween; and first and second external electrodes disposed on the end surfaces of the ceramic body and electrically connected to the first and second internal electrodes, respectively, wherein each of the first and second external electrodes includes a first external electrode layer containing a glass component and disposed on the end surface of the ceramic body and a second external electrode layer being glass-free and covering the first external electrode layer.

The first and second external electrode layers may be extended from the end surfaces of the ceramic body to portions of both main surfaces and both side surfaces of the ceramic body.

A content of the glass component in the first external electrode layer may be 3 wt % to 15 wt %.

The first external electrode layer may include: a head portion containing the glass component and disposed on the end surface of the ceramic body; and a band portion formed of a glass layer and extended from both ends of the head portion to both main surfaces of the ceramic body.

A content of the glass component in the head portion may be 7 wt % to 15 wt %.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically showing a multilayer ceramic capacitor to be embedded in a board according to an exemplary embodiment of the present disclosure;

FIG. 2 is a cross-sectional view of line A-A′ of FIG. 1; and

FIG. 3 is a cross-sectional view of a multilayer ceramic capacitor to be embedded in a board according to another exemplary embodiment of the present disclosure, cut in a length-thickness direction.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Multilayer Ceramic Capacitor to be Embedded in Board

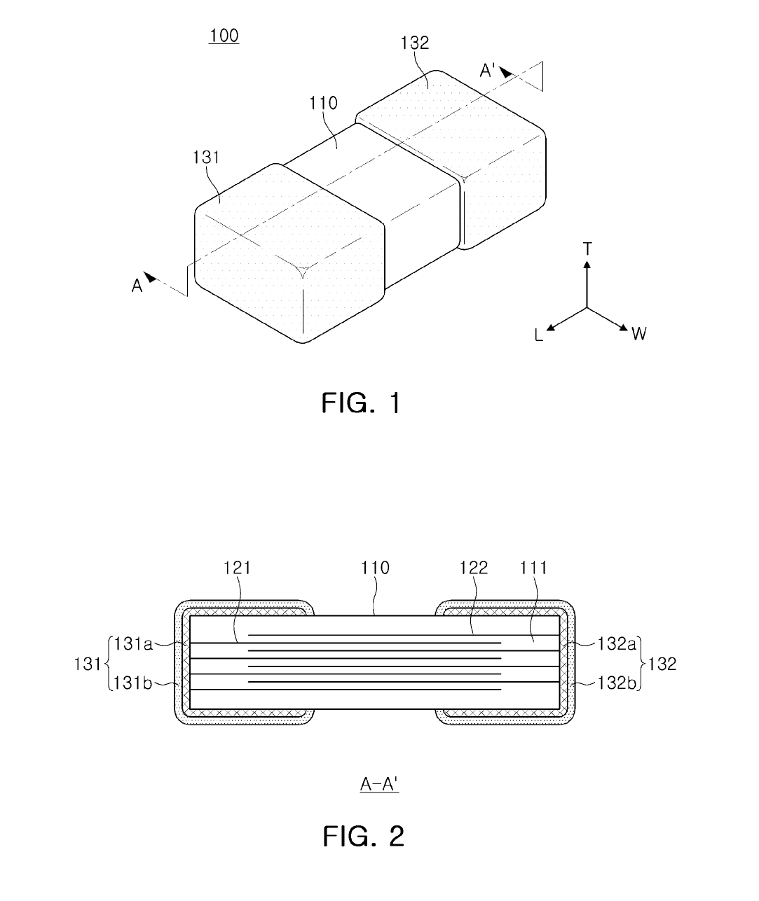

FIG. 1 is a perspective view schematically showing a multilayer ceramic capacitor to be embedded in a board according to an exemplary embodiment of the present disclosure; and FIG. 2 is a cross-sectional view of line A-A′ of FIG. 1.

Referring to FIGS. 1 and 2, a multilayer ceramic capacitor 100 to be embedded in a board according to an exemplary embodiment of the present disclosure may include a ceramic body 110, a plurality of first and second internal electrodes 121 and 122, and first and second external electrodes 131 and 132.

Here, the first and second external electrodes 131 and 132 may be formed to have a double-layer structure in which the first external electrode 131 includes a first external electrode layer 131a and a second external electrode layer 131b, and the second external electrode 132 includes a first external electrode layer 132a and a second external electrode layer 132b.

The ceramic body 110 may be formed by stacking a plurality of dielectric layers 111 in a thickness direction and then sintering the plurality of dielectric layers 111. A shape and a dimension of the ceramic body 110 and the number of stacked dielectric layers 111 are not limited to those shown in FIGS. 1 and 2.

The plurality of dielectric layers 111 forming the ceramic body 110 may be in a sintered state. Adjacent dielectric layers 111 may be integrated with each other so that boundaries therebetween are not readily apparent without using a scanning electron microscope (SEM).

A shape of the ceramic body 110 is not particularly limited, but may be, for example, a hexahedral shape.

In the present exemplary embodiment, for convenience of explanation, both main surfaces of the ceramic body 110 refer to surfaces of the ceramic body 110 opposing each other in a thickness direction, both end surfaces of the ceramic body 110 refer to surfaces of the ceramic body 110 connecting the main surfaces to each other and opposing each other in a length direction, and both side surfaces of the ceramic body 110 refer to surfaces of the ceramic body 110 vertically intersecting with the end surfaces and opposing each other in a width direction.

Directions of the ceramic body 110 will be defined in order to clearly describe exemplary embodiments of the present disclosure. L, W and T shown in FIG. 1 refer to a length direction, a width direction, and a thickness direction, respectively.

Here, the thickness direction may be the same as a stacked direction in which the dielectric layers are stacked.

The first and second internal electrodes 121 and 122, having different polarities, may be formed by printing a conductive paste containing a conductive metal on the dielectric layers 111 at a predetermined thickness.

Here, the first and second internal electrodes 121 and 122 may be stacked to be alternately exposed through the end surfaces of the ceramic body 110, respectively, with each of the dielectric layers 111 interposed therebetween. The first and second internal electrodes 121 and 122 may be electrically insulated from each other by the dielectric layers 111 disposed therebetween.

In addition, the first and second internal electrodes 121 and 122 may be electrically connected to first and second external electrodes 131 and 132 through portions thereof alternately exposed through the end surfaces of the ceramic body 110, respectively.

Therefore, when voltage is applied to the first and second external electrodes 131 and 132, electric charges may be accumulated between the first and second internal electrodes 121 and 122 facing each other. In this case, capacitance of the multilayer ceramic capacitor 100 may be in proportion to an area of an overlapped region between the first and second internal electrodes 121 and 122.

Thicknesses of the first and second internal electrodes 121 and 122 may be determined depending on intended use of the multilayer ceramic capacitor. For example, the thicknesses of the first and second internal electrodes 121 and 122 may be determined to be in the range of 0.2 μm to 1.0 μm in consideration of a size of the ceramic body 110. However, the present disclosure is not limited thereto.

In addition, the conductive metal contained in the conductive paste forming the first and second internal electrodes 121 and 122 may include, for example, any one of silver (Ag), palladium (Pd), platinum (Pt), nickel (Ni), and copper (Cu), or an alloy thereof. However, the present disclosure is not limited thereto.

In addition, as a method of printing the conductive paste, a screen printing method, a gravure printing method, or the like, may be used. However, the present disclosure is not limited thereto.

The first and second external electrodes 131 and 132 may be formed on both end surfaces of the ceramic body 110, respectively, and may be electrically connected to the exposed portions of the first and second internal electrodes 121 and 122, respectively.

The first and second external electrodes 131 and 132 may include the first external electrode layers 131a and 132a formed on the end surfaces of the ceramic body 110 and directly contacting the exposed portions of the first and second internal electrodes 121 and 122, and the second external electrode layers 131b and 132b formed to cover the first external electrode layers 131a and 132a.

The first external electrode layers 131a and 132a may be formed of a conductive paste containing a glass component. Sliver (Ag), nickel (Ni), and copper (Cu), or an alloy thereof may be contained as a conductive metal in the conductive paste. However, the present disclosure is not limited thereto.

A content of the glass component in the first external electrode layers 131a and 132a may be 3 wt % to 15 wt %.

Here, when the content of the glass component in the first external electrode layers 131a and 132a is less than 3 wt %, density of the first external electrode layers 131a and 132a is decreased, and thus, pores may be formed. As a result, the glass component may move from a band portion toward surfaces of the first external electrode layers 131a and 132a, such that a thickness of the band portion becomes non-uniform and a surface of the band portion becomes uneven.

In addition, when the content of the glass component in the first external electrode layers 131a and 132a exceeds 15 wt %, an excessive amount of glass is present on interfaces between the first external electrode layers 131a and 132a and the ceramic body 110 to deteriorate electrical connectivity between the external electrodes and the internal electrodes, causing a decrease in capacitance.

The second external electrode layers 131b and 132b may be formed of a conductive paste that does not contain a glass component. Sliver (Ag), nickel (Ni), and copper (Cu), or an alloy thereof may be contained as a conductive metal in the conductive paste. However, the present disclosure is not limited thereto.

That is, in a multilayer ceramic capacitor to be embedded in a board according to the related art, copper metal layers are plated on surfaces of external electrodes, such that the external electrodes are not completely dense and pores are present in the external electrodes. In this case, since a plating solution permeates through the pores, insulation reliability is decreased.

However, with the double-layer external electrode structure according to the present exemplary embodiment, the vias may be formed using a laser beam without plating the metal layers on the surfaces of the external electrodes, thereby preventing the occurrence of a pin-hole defect in which plating is not adequately performed on the glass portions due to a beading phenomenon in which the glass component moves to the surfaces of the external electrodes when the content of the glass component in the external electrodes is increased, or a decrease in capacitance caused when the glass component is concentrated on the interfaces between the external electrodes and the ceramic body to deteriorate electrical connectivity between the internal electrodes and the external electrodes, a blister defect, and the like.

### Experimental Example

Multilayer ceramic capacitors including copper plating layers according to the related art and multilayer ceramic capacitors including glass-free external electrode layers according to inventive examples were manufactured to have a 1005 standard size, and an accelerated aging test was performed on these multilayer ceramic capacitors while changing thicknesses of external electrodes.

In the accelerated aging test, samples of which an insulation resistance drops to 10⁵Ω or below within 3 hours after a direct current (DC) voltage of 2V is applied to 200 samples of corresponding multilayer ceramic capacitors according to Comparative and Inventive Examples at 105° C. were measured and evaluated.

TABLE 1

| | |
|---|---|
| | High Temperature Accelerated |
| Thickness (μm) | Aging Test |

| of External | Comparative | Inventive |
|---|---|---|
| Electrodes | Examples | Examples |
| 6 | 81/200 | 0/200 |
| 8 | 63/200 | 0/200 |
| 10 | 11/200 | 0/200 |
| 12 | 3/200 | 0/200 |
| 14 | 0/200 | 0/200 |
| 16 | 0/200 | 0/200 |
| 18 | 0/200 | 0/200 |
| 20 | 0/200 | 0/200 |

Referring to Table 1, it can be seen that in case of Comparative Examples, deterioration did not occur in the accelerated aging test only when the thickness of the external electrodes was 14 μm or greater.

However, it can be seen that in case of Inventive Examples, deterioration did not occur even when the thickness of the external electrodes was 6 μm. That is, a high temperature reliability improving effect was obtained even when the external electrodes are thin.

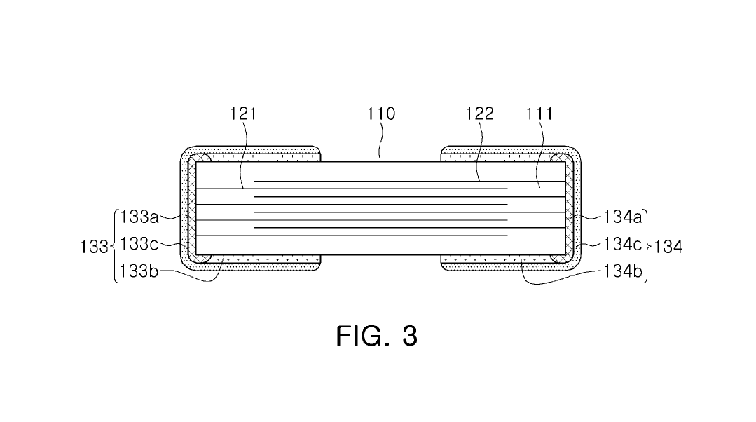

Meanwhile, referring to FIG. 3, a first external electrode 133 may include a first external electrode layer divided into a head portion 133a and a band portion 133b and a second external electrode layer 133c covering the head portion 133a and the band portion 133b of the first external electrode layer, and a second external electrode 134 may include a first external electrode layer divided into a head portion 134a and a band portion 134b and a second external electrode layer 134c covering the head portion 134a and the band portion 134b of the first external electrode layer.

The head portions 133a and 134a may be formed of a conductive paste containing a glass component and be formed on both end surfaces of the ceramic body 110, respectively, and the band portions 133b and 134b may only be formed of a glass layer and be extended from both ends of the head portions 133a and 134a to both main surfaces of the ceramic body 110, respectively.

A content of the glass component in the head portions 133a and 134a may be 7 wt % to 15 wt %.

Here, when the content of the glass component in the head portions 133a and 134a is less than 7 wt %, adhesive force between the ceramic body 110 and the external electrodes is weak, such that distal end portions of the external electrodes may be separated.

In addition, when the content of the glass component in the head portions 133a and 134a exceeds 15 wt %, an excessive amount of glass is present on interfaces between the first external electrode layers 131a and 132a and the ceramic body 110 to deteriorate electrical connectivity between the external electrodes and the internal electrodes, causing a decrease in capacitance.

Here, since descriptions related to the ceramic body 110 and the first and second internal electrodes 121 and 122 are the same as those in the previous exemplary embodiment of the present disclosure, details thereof will be omitted in order to avoid redundancy.

Metal powder particles need to be grain-refined in order to increase the density of the external electrodes. However, when the metal powder particles are grain-refined, a sintering start temperature is lowered, such that the metal powder particles start to be sintered before the glass component arrives at interfaces between the external electrodes and the ceramic body, thereby causing delamination between the external electrodes and the ceramic body due to contraction stress occurring in distal end portions of the external electrodes.

In the present exemplary embodiment, the first external electrode layers including the head portions containing the glass component and the band portions only formed of the glass layer may be formed on the ceramic body before the second external electrode layers are formed. Therefore, since a plating layer for embedding is omitted, the delamination defects occurring in the distal end portions of the external electrodes, the permeation of a plating solution through the delaminated portions, and a blister problem may be prevented.

As set forth above, according to exemplary embodiments of the present disclosure, the glass-free external electrode portions may be formed in the surfaces of the external electrodes, such that the vias may be formed using the laser beam without plating the metal layers on the surfaces of the external electrodes, thereby preventing the occurrence of a pin-hole defect in which plating is not adequately performed on the glass portions due to a beading phenomenon in which the glass component moves to the surfaces of the external electrodes when the content of the glass component in the external electrodes is increased, or a decrease in capacitance caused when the glass component is concentrated on the interfaces between the external electrodes and the ceramic body to deteriorate electrical connectivity between the internal electrodes and the external electrodes, a blister defect, and the like.

While exemplary embodiments have been shown and described above, it will be apparent to those skilled in the art that modifications and variations could be made without departing from the spirit and scope of the present disclosure as defined by the appended claims.

What is claimed is:

1. A multilayer ceramic electronic component to be embedded in a board, the multilayer ceramic electronic component comprising:
a ceramic body in which a plurality of dielectric layers are stacked;
a plurality of first and second internal electrodes disposed to be alternately exposed to both end surfaces of the ceramic body, respectively, with at least one of the dielectric layers interposed therebetween; and
first and second external electrodes disposed on the end surfaces of the ceramic body and electrically connected to the first and second internal electrodes, respectively,
wherein each of the first and second external electrodes includes a first external electrode layer containing a glass component and disposed on the end surface of the ceramic body and a second external electrode layer being glass-free and covering the first external electrode layer.

2. The multilayer ceramic electronic component of claim 1, wherein the first and second external electrode layers are extended from the end surfaces of the ceramic body to portions of both main surfaces and both side surfaces of the ceramic body.

3. The multilayer ceramic electronic component of claim 1, wherein a content of the glass component in the first external electrode layer is 3 wt % to 15 wt %.

4. The multilayer ceramic electronic component of claim 1, wherein the first external electrode layer includes:
a head portion containing the glass component and disposed on the end surface of the ceramic body; and
a band portion formed of a glass layer and extended from both ends of the head portion to both main surfaces of the ceramic body.

5. The multilayer ceramic electronic component of claim 4, wherein a content of the glass component in the head portion is 7 wt % to 15 wt %.
